(19) United States
(12) Patent Application Publication
(10) Pub. No.: US 2006/0153185 A1
(43) Pub. Date: Jul. 13, 2006

(54) Method and apparatus for dynamically changing ring size in network processing

(75) Inventors: Sanjeev Jain, Shrewsbury, MA (US); Mark B Rosenbluth, Uxbridge, MA (US)

Correspondence Address: Jung-hua Kuo Attorney at Law;c/o PortfolioIP, P.O. Box 52050., Minneapolis, MN, 55402, US

(73) Assignee: Intel Corporation, Santa Clara, CA (US)

(21) Appl. No.: 11/026,449

(22) Filed: Dec. 28, 2004

(51) Int. Cl. H04L 12/56; H04L 12/28

(52) U.S. Cl. 370/389

(57) ABSTRACT

Systems and methods for dynamically changing ring size in network processing are disclosed. In one embodiment, a method generally includes requesting a free memory block from a free block pool manager by a ring manager for a corresponding ring when a first memory block is filled, receiving an address of a free memory block from the free block pool manager in response to the request from the ring manager, storing the address of the free memory block in the first memory block by the ring manager, the storing linking the free memory block to the first memory block as a next linked memory block to the first memory block, and repeating the requesting, receiving and storing for each additional linked memory blocks. An external service thread may be assigned to fulfill block fill-up requests from the free block pool manager.

### BACKGROUND

In network communications systems, data is typically transmitted in packages called “packets” or “frames,” which may be routed over a variety of intermediate network nodes before reaching their destination. These intermediate nodes (e.g., controllers, base stations, routers, switches, and the like) are often complex computer systems in their own right, and may include a variety of specialized hardware and software components.

Often, multiple network elements will make use of a single resource. For example, multiple servers may attempt to send data over a single channel. In such situations, resource allocation, coordination, and management are important to ensure the smooth, efficient, and reliable operation of the system, and to protect against sabotage by malicious users.

Packets move through a network processor along a pipeline from one network processing unit to another. Each instance of the pipeline passes packets from one stage to the next, across network processing unit boundaries. Thus at any one time, a network processor may have dozens of packets in various stages of processing.

In a network processor application, the pipeline spans several network processing units. For example, a receive network processing unit reads a data stream from multiple ports, assembles packets, and stores the packets in memory by placing the packets onto a ring that may serve as a holding point for the remainder of the packet processing performed by a second group of network processing units. Traditionally, these rings use a pre-allocated memory region. In addition, conventional rings use a control structure that includes a head pointer that points to the current GET location, a tail pointer that points to the current PUT location, a count that defines the number of entries in the ring, and a size that defines the maximum size of ring.

### BRIEF DESCRIPTION OF THE DRAWINGS

Reference will be made to the following drawings, in which:

FIG. 1 is a block diagram illustrating one embodiment of a dynamically sized or flexible ring structure that may be utilized in a network processor.

FIG. 2 illustrates an exemplary ring control structure.

FIG. 3 illustrates a free block pool manager for managing and dynamically changing sizes of rings.

FIG. 4 is a flowchart of an illustrative process for managing and dynamically changing sizes of rings.

FIG. 5 is a flowchart of an illustrative process by a ring manager in dynamically changing sizes of rings.

FIG. 6 is a block diagram of an exemplary network processor in which the systems and method for dynamically changing size of rings may be implemented.

### DESCRIPTION OF SPECIFIC EMBODIMENTS

Systems and methods are disclosed for dynamically changing ring size in network processing. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

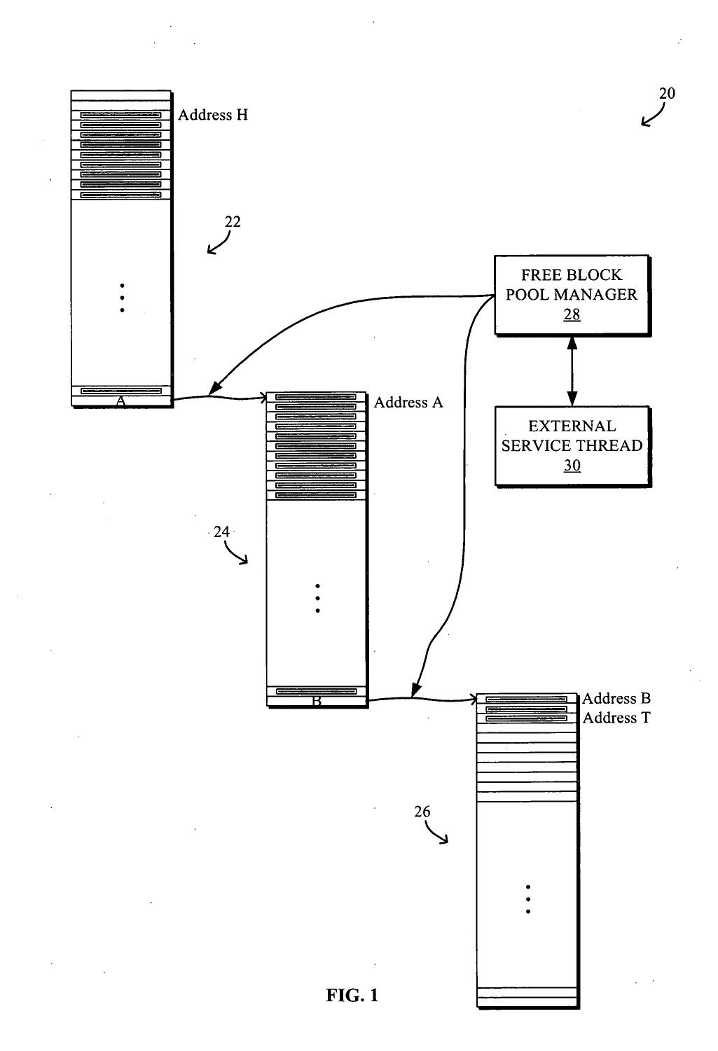

FIG. 1 is a block diagram illustrating one embodiment of a dynamically sized or flexible ring structure 20 that may be utilized in a network processor. The flexible ring structure 20 is configured to dynamically expand or shrink depending on the current utilization of the respective ring. In particular, flexible rings are not pre-assigned a piece of memory. Instead, each flexible ring obtains memory from a defined free memory block pool when additional memory is needed. Such a flexible and dynamic configuration results in more efficient memory capacity utilization. In the flexible ring scheme as described herein, fixed size memory blocks are connected in a linked list manner. A new memory block is obtained from the free memory block pool when the currently attached memory block becomes full. The newly obtained memory block is added to the ring by linking the newly obtained memory block to the full memory block. For example, the full memory block may point to the new, i.e., next attached, block by storing the address of the next attached block in its last memory location.

Such a flexible ring structure is in contrast to conventional ring structures that are fixed in size. With conventional ring structures, if there are multiple rings defined in a given memory channel, the rings do not share unused capacity with one another. Such an approach causes under utilization of memory resources.

The exemplary ring structure 20 shown in FIG. 1 has three linked memory blocks 22, 24, 26. A free block pool manager 28 and an external service thread 30 are provided to manage the dynamic or flexible allocation and de-allocation of free blocks to and from the ring as necessary. The first linked block 22 is linked or attached to block 24 in that the last memory location of block 22 stores address A, the address of block 24. Similarly, block 24 is linked to block 26 in that the last memory location of block 24 stores address B, the address of block 26. In one embodiment, each memory block 22, 24, 26 has a buffer size of 128 B or 32 long words (LW) such that each block can store up to 31 data entries and 1 memory address entry in its last memory location for pointing to the next linked block. In the example shown in FIG. 1, there are 3 memory buffer blocks in use with a total of 63 elements stored in the ring (29 in block 22, 31 in block 24 and 3 in block 26). As will be described in more detail below, a head or remove pointer H of the ring points to address H in block 22, the first linked block. A tail or put pointer T of the ring points to address T in block 26, the last linked block.

FIG. 2 illustrates an exemplary 16B ring control structure 34 for defining the flexible ring structure for burst-of-4 memory. In particular, the ring control structure 34 includes a head or remove pointer that contains a 3B head address H. The head address H is the head or get pointer pointing to address H. A 3B head address H can point up to 64 MB of memory which is accessible in 4B granularity. The head pointer may also include a ring size encoding to define the maximum size of the ring, a linked or flat bit that defines if the ring is flexible or flat, and a threshold that defines a fullness criterion. Specifically, the ring size encoding may contain 4 bits to define the maximum size of the ring in encoded form from 512 bytes to 64 MB, for example. When the “linked or flat” bit defines the ring as flat, the ring size encoding defines when to wrap around and return to the start of the ring. In other words, in a flat ring, linked blocks are not utilized. The threshold may contain 3 bits to define the fullness criterion when a given service thread is to be notified, e.g., 32, 64, 128, 256, 512, 1k, ½ max size or ¾ max size entries away from being full.

The ring control structure 34 also includes a tail or insert pointer that contains a tail address T. A write entry residue may be 4B to cache odd 4 write bytes when dealing with burst-of-4 memory as in burst-of-4 memory, writes are performed in 8 bytes. Thus odd 4 bytes are maintained in the write entry residue and are written to memory as full 8 bytes when the next 4 bytes of PUT request arrives. Although not shown, an optional read entry residue may be provided as reads are similarly performed in 8 byte increments when dealing with burst-of-4 memory. The read entry residue caches odd 4 read bytes which are returned to the requester when a GET request for the next 4 bytes arrives.

The ring control structure 34 further includes a count for the number of 4 byte entries in the ring. The count may be a 3B parameter. ME#/TH#/signal# defines the external agent ID that needs to be notified when a critical condition happens. For example, if threshold is reached or exceeded or if the number of available memory blocks falls below a predefined threshold, the external agent can be notified for controlling whether to stop sending entries and/or to add memory blocks. It is noted that the configuration as illustrated and described herein is merely illustrative and various other configuration may be similarly implemented.

Depending on the number of flexible rings, local storage to hold the ring control structures 34 may be added. Merely as an example, for a 64 ring design, a total of 64×16B or 1 kB of internal memory to hold the corresponding ring control structures 34 can be added. The ring control structure 34 may be treated like control and status registers (CSRs). An external host may initialize, e.g., upon boot-up, the ring control registers with their predetermined base values.

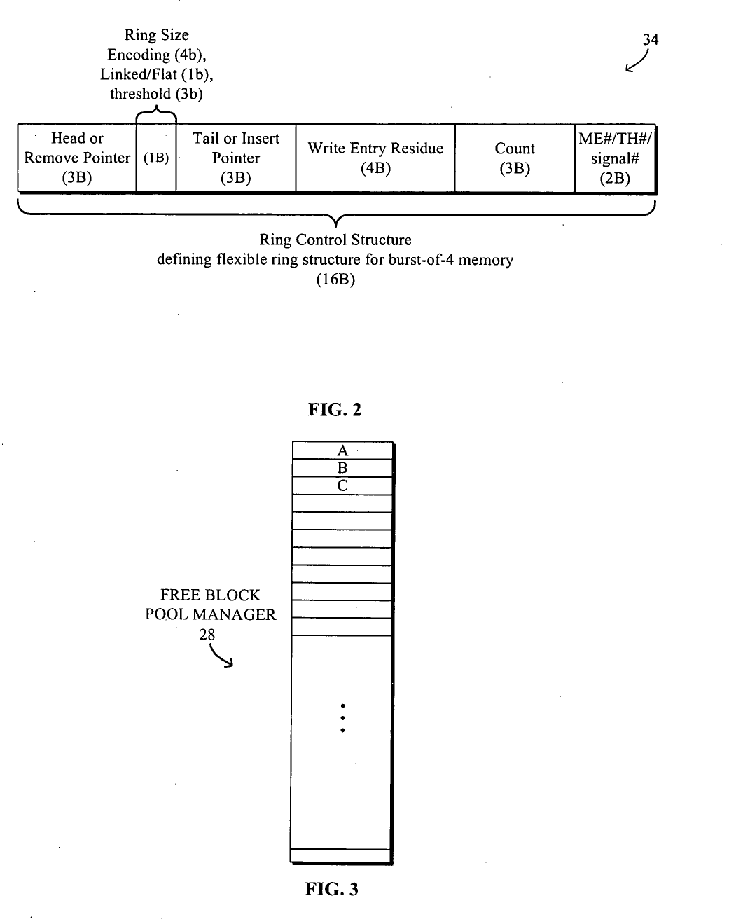

The external host may also initialize free block pool in external memory such as in dynamic random access memory (DRAM) channel or in static random access memory (SRAM) channel. The external host may also assign the external service thread 30 (as shown in FIG. 1) to maintain the external free block pool and to perform block fill service for the local free block pool manager 28. FIG. 3 illustrates the local free block pool manager 28 employed for managing and facilitating in dynamically changing sizes of rings. The local free block pool manager 28 may be a 64 entry deep first-in-first-out (FIFO) table. Each entry can be 24 bits long pointing to the head of each free block.

Upon determining its local free block pool empty at boot-up, the local free block pool manager 28 generates and transmits a free block fill-up request to the external service thread 30 through its next neighbor FIFO in order to fill up the local free block pool. In response, the external service thread 30 returns a free block pool, e.g., a free block pool of up to 32B. The return by the external service thread 30 may be performed using a write to a dummy address in the SRAM channel which an SRAM controller may then direct to the free block pool manager 28. Optionally, local blocks that become freed up and no longer needed by the free block pool manager 28 may be transmitted to the external service thread 30 to be placed into the external free block pool.

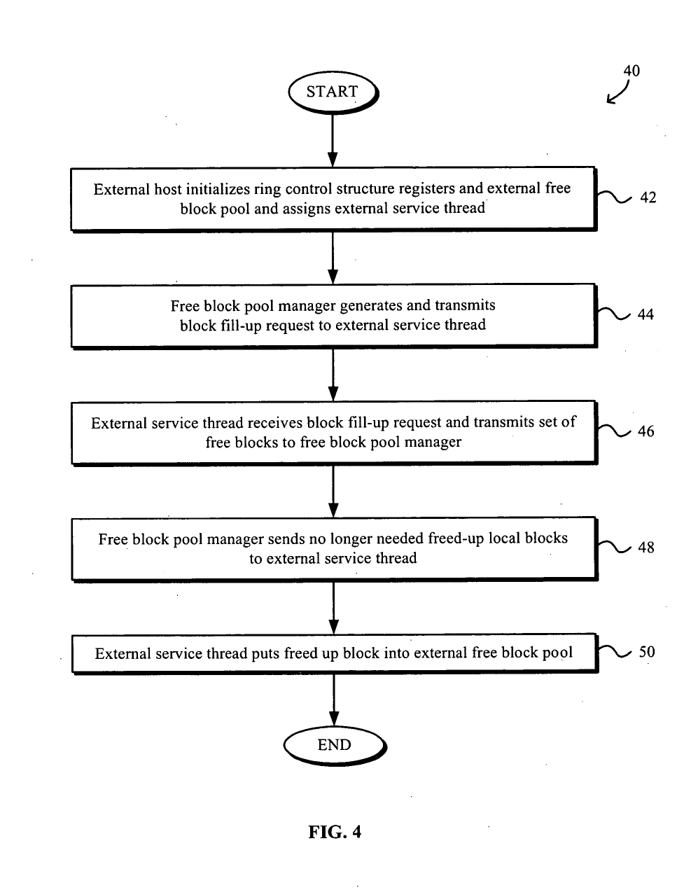

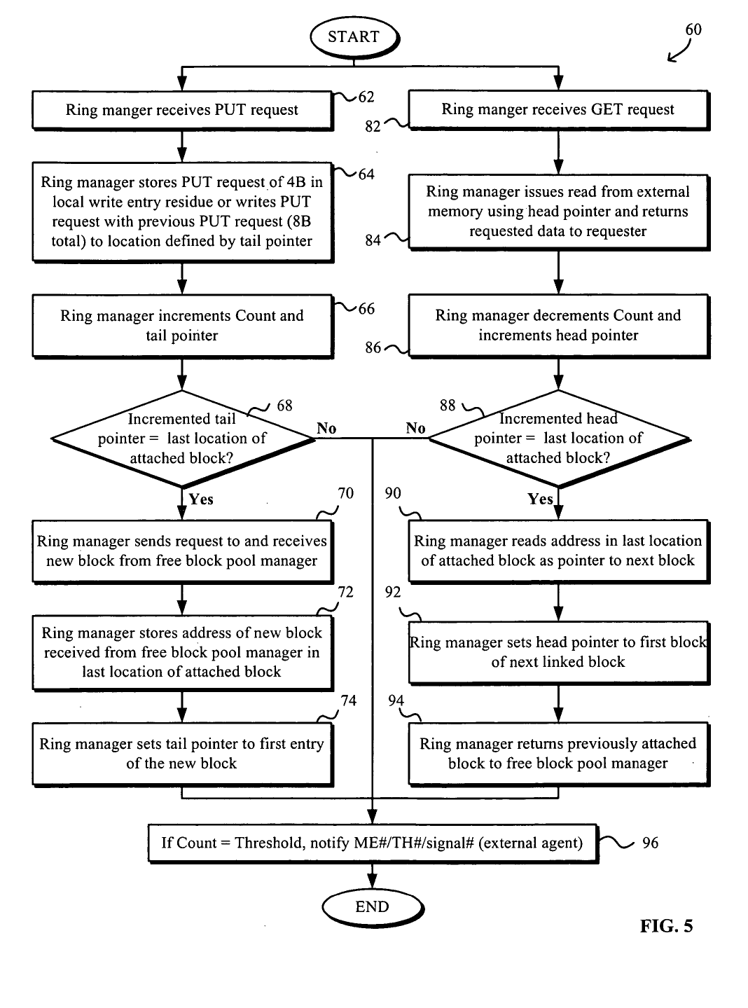

FIG. 4 is a flowchart of an illustrative process 40 for managing and facilitating in dynamically changing sizes of rings by the free block pool manager and the external service thread. At block 42, an external host initializes ring control structure registers and an external free block pool. In addition, the external host assigns the external service thread to facilitate the free block pool manager in managing dynamically changing sizes of rings. When operation begins, upon finding its local pool empty, the free block pool manager sends a request to the external service thread for fill-up at block 44. In particular, the free block pool manager generates and transmits a block fill-up request to the external service thread. In response, the external service thread transmits a set of free blocks to the free block pool manager at block 46. As one example, the external service thread may transmit a set of 8 free block locations to the free block pool manager.

During operation, when local blocks are freed-up and no longer needed by the free block pool manager, the free block pool manager sends the free-up blocks to the external service thread at block 48. The external service thread puts the freed up blocks into the external free block pool at block 50.

FIG. 5 is a flowchart of an illustrative process 60 by a ring manager in dynamically changing sizes of rings. In general, the left side of the flowchart of FIG. 5 illustrates the processing of each PUT request while the right side of the flowchart illustrates the processing of each GET request. The processing of each PUT and GET request is described in turn below.

When the ring manager receives a PUT request for a corresponding ring at block 62, the ring manager stores the PUT request of 4B in a local write entry residue or writes the PUT request with a previous PUT request (8B total) to location defined by tail pointer. In particular, when the ring manager receives a 4B PUT request, the ring manager may store the 4B PUT request in its local write entry residue when writes are to be performed in 8B increments. When ring manager for this ring receives the next PUT request of 4B, the ring manager writes a total of 8B. The write is performed at the location defined by the tail pointer. The ring manager increments Count and increments the tail pointer by 2 locations at block 66. In particular, Count is incremented on every long word PUT request.

If the incremented tail pointer is the last location of the currently attached block as determined at decision block 68, the ring manager sends a request for a new block to and receives the new block from the free block pool manager at block 70. The ring manager then stores the address of the new block received from the free block pool manager in the last location of the currently attached block at block 72. The ring manager then sets the tail pointer to the first entry of the new block and the new block then also becomes attached (linked) at block 74.

When the ring manager receives a GET request for a corresponding ring at block 82, the ring manager uses the head pointer to issue a read of 8B from the external memory and returns the requested data to the requester at block 84. Upon obtaining the data from the external memory, the ring manager may return the requested 4B word to the requester and discards the remaining 4B. As noted, a read residue may be maintained such that, rather than discarding the remaining 4B word, then remaining 4B word is maintained in the read residue with the read residue valid bit set. Upon receiving the next GET request, the ring manager retrieves the requested data from the read residue.

At block 86, the ring manager decrements Count and increments the head pointer by 1 location. In particular, Count is decremented on every long word GET request.

If the incremented head pointer is the last location of the currently attached block as determined at decision block 88, the ring manager reads the address stored in the last location of the currently attached block, i.e., the link address or pointer to the next attached block at block 90. The ring manager sets the head pointer to the first block of the next linked block at block 92 and returns the previously attached block to the free block pool manager at block 94.

After performing the PUT or GET process, if the Count is equal to the threshold as defined in the ring control structure by the 3-bit encoded threshold parameter for the ring as described above, the external agent defined by ME#/Thread#/Signal# is notified at block 96. In particular, the ring manager also notifies external agent defined by ME#/Thread#Signal# when, for example, the free block pool reaches a critical low threshold.

A ring size encoding of, e.g., 4 bits defines the maximum ring size of 128 LW or 512B to 16M LW or 64 MB in encoded form. It is noted that process 60 is implemented only when linked mode is selected in the ring control structure. If flat mode is selected instead, the block size for the corresponding ring is equal to the maximum size as defined for the ring. In addition, the head and tail pointers wrap aligning with the maximum size as defined for the ring. An external service thread is not employed in the flat mode.

The dynamic changing of the ring sizes allows the allocation of a pool of free memory to be shared amongst a set of rings depending on current memory needs of each ring. Such dynamic changing of the ring sizes rather than the allocation of dedicated memory for each ring improves memory capacity utilization and thus reduces the overall memory capacity requirements for the rings, especially when the rings are used in a mutually exclusive way. For example, if a Ethernet packet is dropped, its parameters can go to Ethernet rings and if a POS packet is dropped, its parameters can go into POS ring. Since a packet is inserted into only one ring, the total memory utilization for each packet is fixed and such a property can thus be exploited in implementing the dynamic changing of the ring sizes.

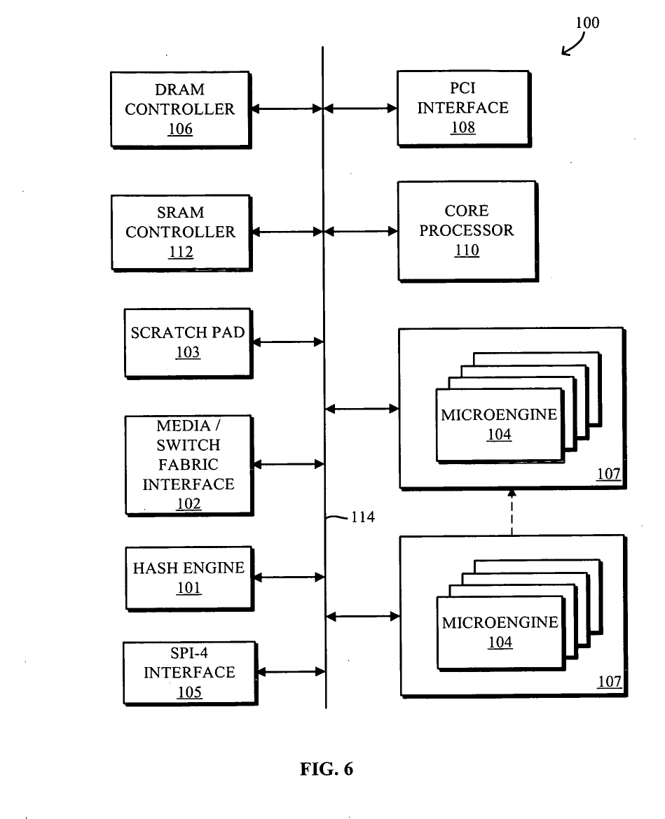

As noted, the systems and methods described herein can be implemented in a network processor for a variety of network processing devices such as routers, switches, and the like. FIG. 6 is a diagram of an exemplary network processor 100. As is known, network processors are typically used to perform packet processing and/or other networking operations. Some network processors—such as the Internet Exchange Architecture (IXA) network processors produced by Intel Corporation of Santa Clara, Calif.—are programmable, which enables the same network processor hardware to be used for a variety of applications, and also enables extension or modification of the network processor's functionality via new or modified programs.

The network processor 100 shown in FIG. 6 has a collection of microengines 104, arranged in clusters 107. Microengines 104 may, for example, comprise multi-threaded, Reduced Instruction Set Computing (RISC) processors tailored for packet processing. As shown in FIG. 6, network processor 100 may also include a core processor 110 (e.g., an Intel XScale® processor) that may be programmed to perform “control plane” tasks involved in network operations, such as signaling stacks and communicating with other processors. The core processor 110 may also handle some “data plane” tasks, and may provide additional packet processing threads.

Network processor 100 may also feature a variety of interfaces that carry packets between network processor 100 and other network components. For example, network processor 100 may include a switch fabric interface 102 (e.g., a Common Switch Interface (CSIX)) for transmitting packets to other processor(s) or circuitry connected to the fabric; an interface 105 (e.g., a System Packet Interface Level 4 (SPI-4) interface) that enables network processor 100 to communicate with physical layer and/or link layer devices; an interface 108 (e.g., a Peripheral Component Interconnect (PCI) bus interface) for communicating, for example, with a host; and/or the like. Network processor 100 may also include other components shared by the microengines, such as memory controllers 106, 112, a hash engine 101, and a scratch pad memory 103. One or more internal buses 114 are also provided to facilitate communication between the various components of the system.

It should be appreciated that FIG. 6 is provided for purposes of illustration, and not limitation, and that the systems and methods described herein can be practiced with devices and architectures that lack some of the components and features shown in FIG. 6 and/or that have other components or features that are not shown.

While several embodiments are described and illustrated herein, it will be appreciated that they are merely illustrative. Other embodiments are within the scope of the following claims.

What is claimed is:

1. A method for dynamically changing size of rings in a network application, comprising:
requesting a free memory block from a free block pool manager by a ring manager when a first memory block is filled;
receiving an address of a free memory block from the free block pool manager in response to the request from the ring manager;
storing the address of the free memory block in the first memory block by the ring manager, the storing links the free memory block to the first memory block as a next linked memory block; and
repeating the requesting, receiving and storing for each additional linked memory blocks.

2. The method of claim 1, in which the storing the address of the free memory block in the first memory block includes storing the address in a last location of the first memory block.

3. The method of claim 1, further comprising:
maintaining a head pointer pointing to a location in a current head memory block, the maintaining including updating the head pointer to point to the next linked memory block to the current head memory block upon the head pointer reaching a location in the current head memory block containing the address of the next linked memory block, the current head memory block becoming a previous current head memory block and the next linked memory block becoming a new current head memory block.

4. The method of claim 3, in which the maintaining the head pointer further includes returning the previous current head memory block to the free block pool manager upon the head pointer being updated to point to the new current head memory block.

5. The method of claim 1, further comprising:
maintaining a tail pointer pointing to a location in a current tail memory block, in which the requesting the free memory block from the free block pool manager is performed upon the tail pointer reaching the last location of the current tail memory block, the maintaining further including updating the tail pointer to point to a first location of the free memory block received from the free block pool manager upon the tail pointer reaching the last location of the current tail memory block.

6. The method of claim 1, further comprising:
assigning an external service thread to facilitate in interfacing between the free block pool manager and an external memory.

7. The method of claim 1, further comprising:
initializing a ring control structure register for each ring by an external host;
initializing an external free block pool by the external host; and
assigning an external service thread to facilitate free memory block fill up in the free block pool manager.

8. The method of claim 1, in which each ring is associated with a ring control structure containing a head pointer, a tail pointer, a write entry residue, a count of a number of entries in the ring, an external agent identification, a ring size encoding defining a maximum size of the corresponding ring, a linked/flat bit defining the ring as linked or non-linked, and a threshold defining a ring fullness criterion.

9. A computer program product embodied on a computer readable medium, the computer program product including instructions that, when executed by a processor, cause the processor to perform actions comprising:
requesting a free memory block from a free block pool manager by a ring manager when a first memory block is filled;
receiving an address of a free memory block from the free block pool manager in response to the request from the ring manager;
storing the address of the free memory block in the first memory block by the ring manager, the storing linking the free memory block to the first memory block as a next linked memory block to the first memory block; and
repeating the requesting, receiving and storing for each additional linked memory blocks.

10. The computer program product of claim 9, in which the storing of the address of the free memory block in the first memory block is storing the address in a last location of the first memory block.

11. The computer program product of claim 9, further including instructions that cause the processor to perform actions comprising:
maintaining a head pointer pointing to a location in a current head memory block, the maintaining including updating the head pointer to point to the next linked memory block to the current head memory block upon the head pointer reaching a location in the current head memory block containing the address of the next linked memory block, the current head memory block becoming a previous current head memory block and the next linked memory block becoming a new current head memory block.

12. The computer program product of claim 11, in which the maintaining the head pointer further includes returning the previous current head memory block to the free block pool manager upon the head pointer being updated to point to the new current head memory block.

13. The computer program product of claim 9, further comprising:
maintaining a tail pointer pointing to a location in a current tail memory block, in which the requesting the free memory block from the free block pool manager is performed upon the tail pointer reaching the last location of the current tail memory block, the maintaining further including updating the tail pointer to point to a first location of the free memory block received from the free block pool manager upon the tail pointer reaching the last location of the current tail memory block.

14. The computer program product of claim 9, further comprising:
assigning an external service thread to facilitate in interfacing between the free block pool manager and an external memory.

15. The computer program product of claim 9, further comprising:
initializing a ring control structure register for each ring by an external host;
initializing an external free block pool by the external host; and
assigning an external service thread to facilitate free memory block fill up in the free block pool manager.

16. The computer program product of claim 9, in which each ring is associated with a ring control structure containing a head pointer, a tail pointer, a write entry residue, a count of a number of entries in the ring, an external agent identification, a ring size encoding defining a maximum size of the corresponding ring, a linked/flat bit defining the ring as linked or non-linked, and a threshold defining a ring fullness criterion.

17. A network processor, comprising:
a core processor;
one or more microengines;
a memory unit, the memory unit containing instructions that, when executed by the core processor or the microengines, cause the network processor to perform actions comprising:
requesting a free memory block from a free block pool manager by a ring manager when a first memory block is filled, each ring manager for managing a memory ring;
receiving an address of a free memory block from the free block pool manager in response to the request from the ring manager;
storing the address of the free memory block in the first memory block by the ring manager, the storing linking the free memory block to the first memory block as a next linked memory block to the first memory block; and
repeating the requesting, receiving and storing for each additional linked memory blocks.

18. The network processor of claim 17, in which each memory ring is associated with a ring control structure containing a head pointer, a tail pointer, a write entry residue, a count of a number of entries in the ring, an external agent identification, a ring size encoding defining a maximum size of the corresponding ring, a linked/flat bit defining the ring as linked or non-linked, and a threshold defining a ring fullness criterion.

19. The network processor of claim 17, in which the memory unit further contains instructions that cause the network processor to perform actions comprising:
assigning an external service thread to facilitate in interfacing between the free block pool manager and an external memory.

20. The network processor of claim 17, in which the memory unit further contains instructions that cause the network processor to perform actions comprising:
initializing a ring control structure register for each ring by an external host;
initializing an external free block pool by the external host; and
assigning an external service thread to facilitate free memory block fill up in the free block pool manager.
